(19) United States
(12) Patent Application Publication
(10) Pub. No.: US 2022/0408913 A1
(43) Pub. Date: Dec. 29, 2022

(54) BOOK SUPPORT FOR KEEPING BOOK OPEN

(71) Applicant: Tae Il LEE, Jecheon-si Chungcheongbuk-do (KR)

(72) Inventor: Tae Il LEE, Jecheon-si Chungcheongbuk-do (KR)

(21) Appl. No.: 17/756,140

(22) PCT Filed: Nov. 25, 2019
(86) PCT No.: PCT/KR2019/016268

§ 371 Date: May 18, 2022

(51) Int. Cl. A47B 23/06; B42D 9/00

(52) U.S. Cl. CPC A47B 23/06; B42D 9/00

(57) ABSTRACT

Proposed is a book support (100) including a stand (120), and a pressure rod (140) having a predetermined length and having one end coupled to the stand (120), wherein the stand (120) supports the book spine while the pressure rod (140) is installed so as to be sandwiched between open pages of the book and presses the book spine such that the book does not rotate, thereby keeping the book open.

### TECHNICAL FIELD

The present disclosure relates generally to a book support and, more particularly, to a book support enabling a book to be kept open, and a turned page to be maintained as it is turned even though the concerned page of the book is turned while the book is kept open.

### BACKGROUND ART

A book is made by binding individual pages, that is, dozens to hundreds of pages. Dozens to hundreds of pages are stacked and bound by adhering one side of the pages with an adhesive or tying them with a string, thereby producing a book. A reader reads the book composed in this way by opening the book. In the process of reading the book, the book should be kept open and pages of the book should not be turned.

In the process of turning pages of the open book to either side of the book, if any one side of the book becomes heavier than the other side of the book, a book spine rotates. If the pages of the book continue to be turned and thus any one side of the book in which the turned pages are stacked becomes heavier than the other side of the book, the rotation angle of the book spine increases, and when the rotation angle of the book spine exceeds a threshold, the book is closed. In this regard, in order to prevent the book from being closed in the process of reading the book with turning the individual pages for reading the book, the turned pages should be pressed by means of the reader's hands or a tool. As the concerned page should be pressed whenever individual pages are turned, the reader cannot freely use his/her hands, thereby bringing about considerable inconvenience.

### PRIOR ART DOCUMENTS

### Patent Documents

(Patent Document 1) Korean Utility Model Registration No. 20-0363150 issued on Sep. 24, 2004

### DISCLOSURE

### Technical Problem

Accordingly, the present disclosure has been made keeping in mind the above problems occurring in the related art, and an objective of the present disclosure is to provide a book support enabling a book to be kept open while a reader reads the book and also enabling the reader to read a desired page without pressing the concerned page even though the concerned page is turned in a state that the book is open, by maintaining the open state of the book, whereby the reader can read the book while freely using his/her hands.

### Technical Solution

In order to accomplish the above objectives, the present disclosure provides a book support including: a stand and a pressure rod having a predetermined length and having one end coupled to the stand, the stand being configured to support a book spine and the pressure rod being configured to be sandwiched between pages of the open book to press a book spine such that the book spine does not rotate, enabling the book to be kept open and thus assisting a reader in reading the book while freely using his/her hands.

### Advantageous Effects

According to the present disclosure, an open state of a book can be maintained without using a reader's hands or a tool while the reader reads the book, and the turned page does not return back to an original position thereof even though the page is turned in the open state of the book, thereby enabling the reader to read the book while freely using his/her hands.

### DESCRIPTION OF DRAWINGS

FIG. 1 is a view illustrating a book support according to an embodiment of the present disclosure.

FIG. 2 is a view illustrating a coupling relation of the book support and a book according to an embodiment of the present disclosure.

FIGS. 3 and 4 are views illustrating states that pages of the book, in which the book support according to an embodiment of the present disclosure is positioned, are turned.

FIG. 5 is a view illustrating a book support according to another embodiment of the present disclosure.

FIG. 6 is a view illustrating a state that the book support of FIG. 5 is positioned in the book.

FIG. 7 is a view illustrating the book support in which a pressure rod is formed to be rotatable.

FIG. 8 is a view illustrating a structure of the book support formed of a wire according to another embodiment of the present disclosure.

FIG. 9 is a view illustrating a state that the book support according to the present disclosure is used with a book stand.

### MODE FOR INVENTION

In order for a reader to read a desired page of a book without pressing the page of the book in the process of reading the book, by maintaining the open state of the book and, even though the concerned page is turned while the book is kept open, enabling the concerned page to be kept turned,

a book support including a stand and a pressure rod having a predetermined length and having one end coupled to the stand is proposed, the book support being configured to support a book spine and the pressure rod being configured to be sandwiched between pages of the open book, so as to press the book such that the book spine does not rotate, thereby serving to maintain the open state of the book.

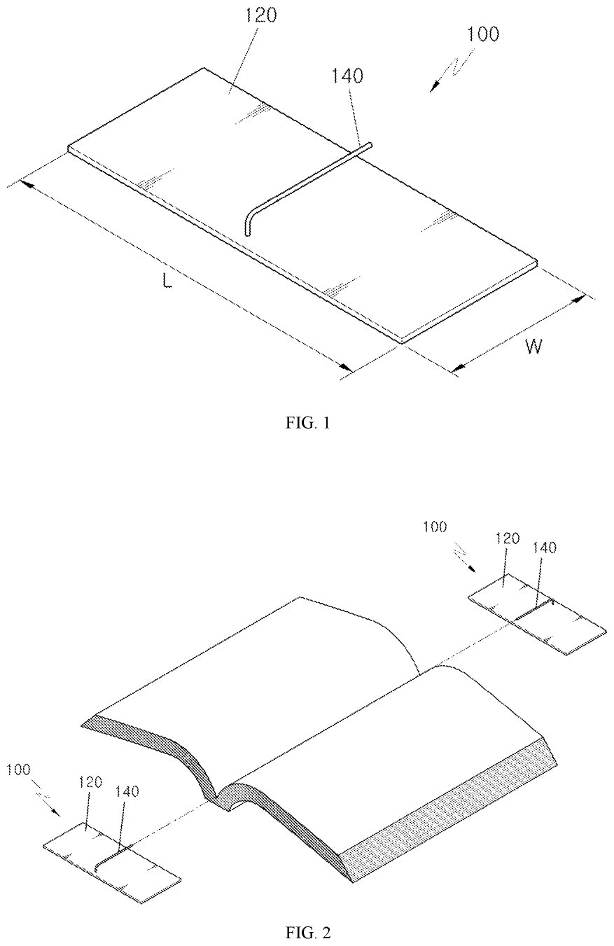

Hereinbelow, exemplary embodiments of the present disclosure will be described in detail with reference to the accompanying drawings, FIGS. 1 to 9.

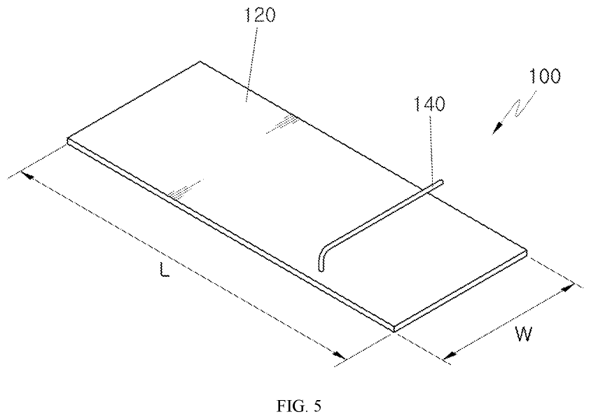

FIG. 1 is a view illustrating a book support according to an embodiment of the present disclosure, and FIGS. 5, 7, and 8 illustrate a book support according to another embodiment of the present disclosure.

As illustrated therein, the book support 100 of the present disclosure includes a stand 120 and a pressure rod 140.

The stand 120 is formed to have a predetermined area. Preferably, the stand 120 is formed in a quadrangle shape having a predetermined length L in a horizontal width direction of the book. More preferably, the stand 120 is formed in a rectangle shape of which the length is longer than the width thereof. The stand 120 may be formed by use of metal or plastic, or also of wood. However, any material is available to be used if the material has a proper strong property.

The pressure rod 140 is formed to have a predetermined gap from an upper surface of the stand 120, and one end of the pressure rod 140 is coupled with the stand 120. The pressure rod 140 may be bent roughly in a “¬” shape and coupled with the stand 120. One end of the pressure rod 140 is coupled with the lower part of the stand 120 on the basis of the width W direction of the stand 120. The pressure rod 140 may be formed to be positioned in a center of the stand 120 on the basis of the length L direction of the stand 120. The pressure rod is formed to have a predetermined length and is sandwiched between pages of the open book.

The diameter of the pressure rod 140 may be approximately about 1 to 2 mm, but no limitation is applied thereto. The length of the pressure rod 140 may be about 5 to 10 cm, but no limitation is also applied thereto.

FIG. 2 is a view illustrating a coupling relation of the book support and the book according to an embodiment of the present disclosure.

The book support 100 of the present disclosure is positioned in an upper end or a lower end of the book in a state that the book is open. A point at which pages of the open book are bound is inserted into a space between the stand 120 and the pressure rod 140. As a result, the pressure rod 140 presses between the pages of the open book to apply pressure thereto, so that the book spine comes into contact with the stand 120. This configuration would be achieved by forming a gap between the pressure rod 140 and the stand 120 enough to press a point between the pages of the book when the book is open.

Meanwhile, the book support 100 is preferably configured as a pair of the books supports formed as a set, and the pair of book supports are positioned in a book. If the pressure rod 140 is formed to have a length reaching the center of the book on the basis of the vertical direction of the book, only one of the book supports 100 may be used. However in this case, as the pressure rod 140 is excessively long, this may cause inconvenience in use. Accordingly, the book supports 100 are used by positioning the pair of the book supports 100 in the upper end and the lower end of the book respectively, in a state that the length of the pressure rod 140 is minimized.

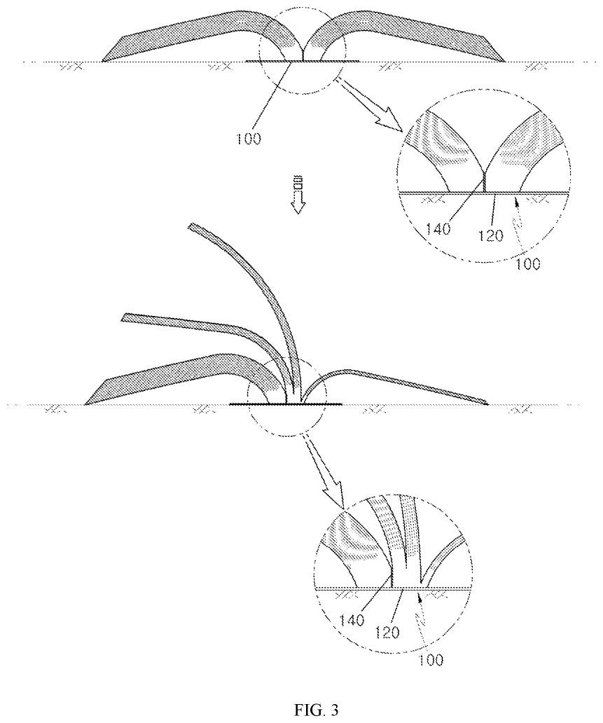

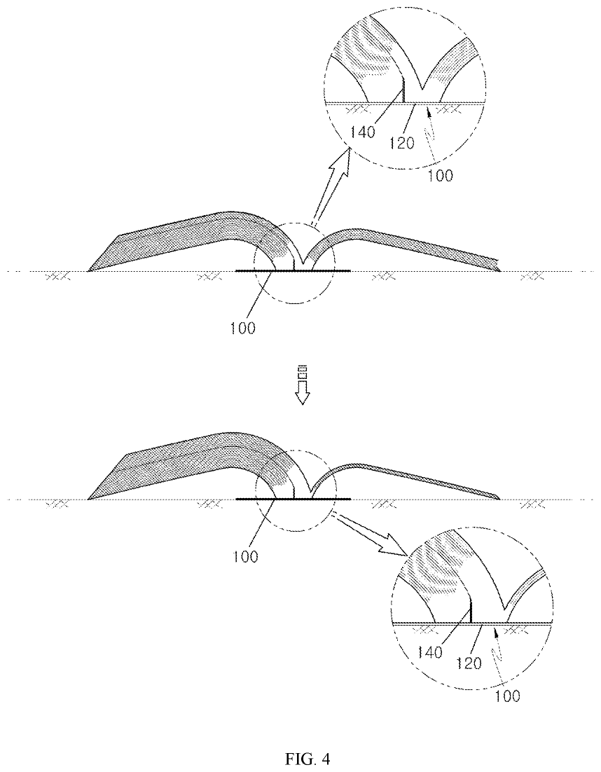

FIGS. 3 and 4 are views illustrating states that the book support according to the present disclosure is positioned and pages of the book are turned, by which operation of the book support according to the present disclosure is shown.

When a page is turned to either side of the book in the state that the book is open, the center of gravity of the book is moved toward the side to which the page is turned according to the weight of the concerned page. According to this, as the pages of the book are turned to one side of the book, a point at which the pages are bound rotates gradually toward the side to which the pages are turned. When the center of gravity of the book exceeds a threshold as the weight of the pages is leaned over to the one side of the book, the book spine rotates excessively, thereby bringing about a situation such that the book cannot be maintained in the open state and then the book is closed. For example, if the pages are turned to the left side in a state that the book is open, the book spine rotates to the left side at the binding point of the book. In addition, as the number of the pages which are turned increases, the rotation angle of the book spine increases and exceeds a threshold, and then, the book is closed.

Here, if the book support 100 of the present disclosure is positioned in a book which is open, the book can be maintained in the open state. Even though pages of the book are turned to one side, the book spine does not rotate because the book spine is in a state of being supported by the stand 120 and the pressure rod 140, and the stand 120 is in a state of being supported on the floor, and thus, the book can be maintained in the open state. Accordingly, if the book support 100 of the present disclosure is positioned in the book which is open, no turned page would return to its original position even though the concerned page is turned while the book is open.

As described above, it is possible to read a desired page without pressing the concerned page using the reader's hands or any tool, thereby allowing the reader's hands to be free. Accordingly, the reader can read the book while using his/her hands for another operation, e.g., handwriting.

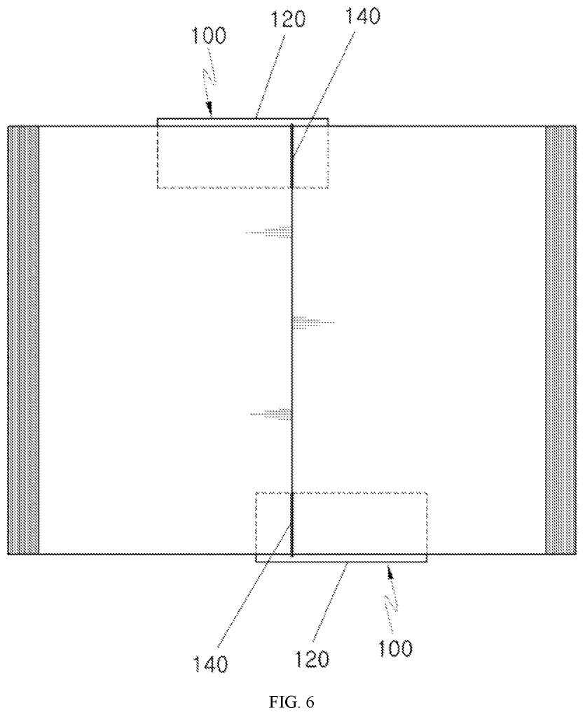

FIG. 5 is a view illustrating the book support according to another embodiment of the present disclosure, and FIG. 6 is a view illustrating the book support of FIG. 5 which is positioned in a book.

In the book support 100 of the present disclosure, the pressure rod 140 may be formed in a position eccentric to one side of the stand 120. The pressure rod 140 is formed to be eccentric to one side on the basis of the length L direction of the stand 120. According to this, the stand 120 is formed to have one side longer than the other side in the length L direction on the basis of the pressure rod 140. This configuration is different from a configuration wherein if the pressure rod 140 is formed in the center of the stand in the length L direction, both sides thereof are similar in length to each other.

The book support 100 configured as described above is configured as a pair of the book supports formed as a set, the pair of which are positioned in the upper end and the lower end of the book respectively. As the book supports 100 are positioned in the upper end and the lower end of the book respectively in the state that the book is open, longer parts of the stand 120 in length on the basis of the pressure rod 140 are positioned oppositely to each other in the upper end and the lower end of the book respectively. Accordingly, although pages of the book are turned to one direction, the book supports 100 positioned in the upper end and the lower end of the book restrict rotation of the book spine. As a result, the book can be maintained in the open state.

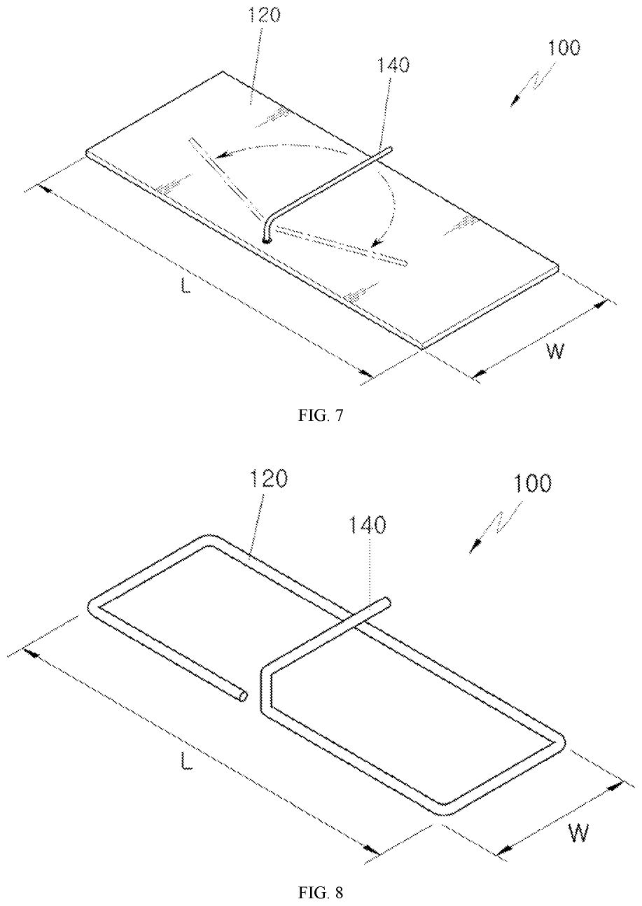

FIG. 7 is a view illustrating the book support in which the pressure rod is formed to be rotatable.

In the book support 100 of the present disclosure, the pressure rod 140 may be formed to be rotatable on the stand 120. An opening is formed in the stand 120, and one end of the pressure rod 140 is fitted into the opening so as not to come out of the opening, but constituting a structure of being rotatable. The structure of coupling one end of the pressure rod 140 with the opening so as not to come out of the opening may employ a manner of coupling the one end of the pressure rod 140 passing through the opening with the opening by means of a nut or by welding a plate having a larger diameter than the opening.

If the pressure rod 140 is coupled with the stand 120 in a rotatable manner as described above, the pressure rod 140 can be rotated for storage or may be received in a separate case when the book support 100 is not used, thereby making it easy to store and carry the book support 100.

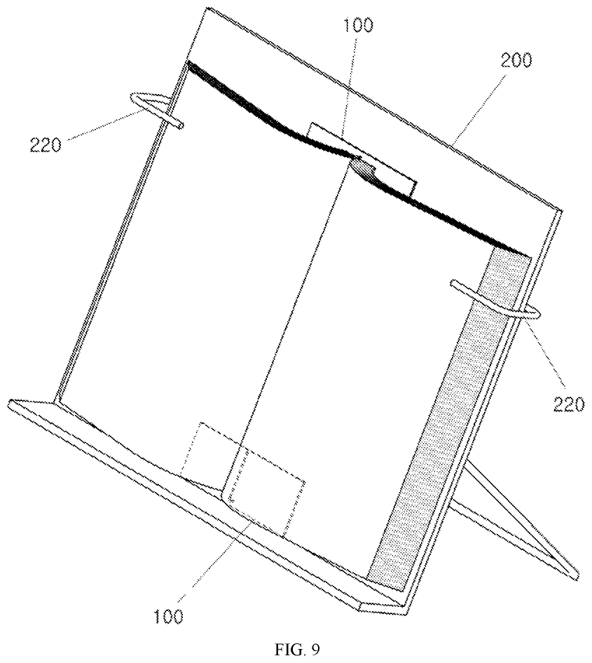

FIG. 8 is a view illustrating a structure of the book support of the present disclosure, which is formed of a wire.

The book support of the present disclosure may be made of a wire which is formed in a predetermined length. The wire is formed in a rectangle shape to constitute a stand 120, and one end of the wire is formed in the center or in a position eccentric to one side in the length L direction of the stand 120, and the pressure rod 140 is integrally formed with the one end of the wire.

FIG. 9 is a view illustrating a state of using the book support of the present disclosure together with a book stand.

The book support of the present disclosure may be used together with the book stand 200. In this case, pressing wires 200 which can elastically press both edges of the open book may be formed in both side edges of the book stand 200. The book support 100 of the present disclosure would enable the book to be more effectively maintained in the open state as the pressing wire 220 presses edges of the book by assisting the book support 100.

In the meantime, the book support 100 of the present disclosure in the above configuration may be assembled to be positioned respectively in the upper part and the lower part of the book stand 200. The book support 100 formed in the upper part is formed to be slidable, and thus is configured such that the book support 100 formed in the upper part can be used with adjusting the position adaptively to the size of the book. As the book support 100 is provided in a state of being coupled with the book stand 200, this configuration provides convenience because no separate preparation of the book support 100 and the book stand 200 is required.

### DESCRIPTION OF THE REFERENCE NUMERALS

100: Book support, 120: Stand,
140: Pressure rod,
200: Book stand, 220: Pressing wire.

1. A book support, comprising:
a stand (120) having a predetermined length in a width direction of a book spine, and being configured to support the book spine in such a manner that the book spine does not rotate in a process of turning pages of the book; and
a pin-shaped pressure rod (140) of which one end is coupled with the stand (120), the pressure rod being configured to be spaced in a predetermined gap from the stand (120) in a length direction of the book spine, so as to allow the pressure rod (140) to be sandwiched between open pages of the book with pressing the book spine, and to have a thickness to inhibit turned pages of the book from returning back to original positions thereof when the pages have been turned in a state that the pressure rod (140) is sandwiched between the pages,
wherein when the stand (120) is put on a floor in a state that certain pages of the book are opened and the pressure rod (140) is sandwiched between the open pages of the book, the stand (120) is supported by the floor in the process of turning the pages, inhibiting rotation of the book spine and also maintaining the turned pages as they are turned, thereby enabling a reader to read the book while turning the pages in a state that the pressure rod (140) is positioned between the open pages of the book.

2. The book support of claim 1, wherein the book support (100) is configured as a pair of the book supports (100) formed as a set, the pair of book supports being positioned at an upper end and a lower end of the book respectively, thereby enabling the book to be kept open.

3. The book support of claim 2, wherein in each of the book supports (100), the pressure rod (140) is provided in the stand (120) at a point leaning to any one side of the stand (120), and the pair of the book supports are positioned at the upper end and the lower end of the book respectively, in such a manner that on the basis of the pressure rod (140), a longer part of one of the book supports is opposite to a longer part of a remaining one of the book supports, thereby enabling the book to be kept open.

4. The book support of claim 1, wherein the pressure rod (140) is coupled to the stand (120) in a rotatable manner, and allows the book to be kept open.

5. The book support of claim 1, wherein the stand (120) is made of a wire which is formed in a predetermined shape, one end of the wire being positioned in a center of the stand (120) or at a point leaning to any one side of the stand (120) in the length (L) direction thereof, and the pressure rod (140) being integrally formed with the one end of the wire, thereby enabling the book to be kept open.
